(19) United States
(12) Patent Application Publication
(10) Pub. No.: US 2003/0018722 A1
(43) Pub. Date: Jan. 23, 2003

(54) Method of managing an update of a changed electronic mail address

(76) Inventors: Lawrence G. Almeda, Rochester Hills, MI (US); Steven T. Morrow, Rochester, MI (US)

Correspondence Address: Lawrence G. Almeda, 2501 S. Christian Hills Drive, Rochester Hills, MI, 48309, US

(21) Appl. No.: 09/909,228

(22) Filed: Jul. 19, 2001

(51) Int. Cl. G06F 15/16

(52) U.S. Cl. 709/206

(57) ABSTRACT

The present invention involves a method of managing an update of a changed email address of a user, wherein the update is managed by a first system. The method comprises providing an old email address and a new email address of the user, and providing an email historical database associated with the first system in which information of the old and new email addresses are stored, wherein the email historical database being in communication with the first system via a communication network. The method further comprises providing a second system for a second client, wherein the second system is in communication with the first system via the communication network. The method further includes sending a subsequent email from the second client, the subsequent email having a subsequent email address, determining the subsequent email is undeliverable, and searching in the email historical database to determine whether the address of the subsequent email is the old email address of the user. The method further includes redirecting the subsequent email message to the new email address of the user, if the subsequent email address is determined to be the old email address of the user.

### CROSS-REFERENCE TO RELATED APPLICATIONS

This application is related to U.S. utility application filed on Jul. 19, 2001 having Ser. No. ______, entitled “SYSTEM AND METHOD OF MANAGING A CHANGE IN AN ELECTRONIC MAIL ADDRESS.”

### BACKGROUND OF THE INVENTION

1. Field of the Invention

The present invention relates to methods of managing an update of a changed electronic mail (e-mail) address of a user.

2. Background Art

Today, the use of email is common practice. As known in the art, sending and receiving email may be performed by individuals via central processing units and respective associated monitors. Users of email range within a broad spectrum of ages involving different purposes. Today, email users as young as grade school students or younger have email access along with sufficient computer operational skills. Many grade school students use email for academic assignments as well as for entertainment and pleasure. High school and college students typically have email access and use email on a day-to-day basis for academic and personal purposes. Moreover, many members of the work force depend on email as a significant means of communication in business, being that email is an effective, generally non-intrusive means of communication between clients. Additionally, several email users implement email solely for personal use. Furthermore, even many elderly individuals have implemented the use of email as an easy form of communication.

As the use of email has grown to be a significant means of communication, the use of email obviously requires a correct email address of a receiving client to whom an email message is sent. Otherwise, the email message will be undeliverable and, thus, will not be received by the receiving client. Maintaining correct email addresses of different email users has in aggregate become relatively time consuming, since email user addresses are dynamic and continuously changing. For example, in the work force, individuals continue to change jobs for various reasons. In such events, business email addresses of such individuals will typically change, since different corporations/companies carry different email addresses for their respective employees. Additionally, as Internet carrier/server rates continue to change, decrease, and/or provide increasingly improved service, email users will continue to shop around, find the best rates, and change Internet carriers accordingly. Such change usually involves having the user add a new email address representing a new Internet carrier/provider, and typically results in terminating a former email address representing an old Internet carrier/provider. In many cases, after an interim, the former email address may be available to be used again as another user's email address.

Current means of making an email address update are adequate, but can be improved. For example, many email users update email addresses in their respective email address books by a method known as a “clip and paste” method. That is, via a central processing unit and an associated monitor, a correct email address is highlighted or blocked by use of a conventional computer mouse or touch pad, and “copied” in any suitable way as known in the art. Then, an email address book is opened which typically has a file associated with an old email address to be changed. Then, the correct or updated email address is “pasted” over the old email address to make the change in email address. This is relatively time consuming.

Other email users may update email addresses by more sophisticated means; however, such means require numerous steps or pull-downs of a number of software windows as known in order to make the update. Moreover, Internet-based email systems provide adequate ways of updating an email address; however, such systems require numerous steps or separate web pages in order to make the update. These too are time consuming.

Current ways of managing an email address change have been challenged with limited success. In many situations, email users may chose to not regularly update or apply use of an email address book. Typically, moderate users of email may not partake in updating an available email address book simply because their volume of email use is relatively low, defeating the practicality of an updated email address book. Such users may keep a written record of email addresses frequently used. Alternatively, such users may merely find a previous (sent or received) email message of a recipient client to whom the user desires to communicate, and access the email address of the recipient client using the “clip and paste” method. Moreover, such user may merely reply to a previously received email message from the recipient client.

However, in situations where the recipient client has changed his/her/it's email address to a new email address, the user typically receives a responding message notifying the user that the recipient's email address no longer exists and is undeliverable. In these situations, the user is faced with inconveniences in obtaining a new email address of the recipient client. For example, the user may be required to contact the recipient client by other means, such as telephone or written correspondence, just to obtain the new email address. The situation obviously becomes more significant wherein a time constraint is involved.

Currently, to lessen such inconveniences, the user must have the new email address of the recipient client. In some instances, the recipient client previously informs the user of the change and the user makes record of such change. On instances in which the user does not take note as to the change, the user may obtain the new email address from a saved email correspondence informing the user of the change, if the recipient client previously informed the user by email. However, managing an updated email address requires steps that both the recipient client and the user must take in order to continue communication with each other. Steps incorrectly taken results in increased time consumption and in decreased efficiency and productivity in most environments.

### SUMMARY OF THE INVENTION

Thus, it is an object of the present invention to provide an improved system and method of automatically managing an update of a changed email address of a user, wherein the system and method are time efficient.

It is another object of the present invention to provide an improved method of managing an update of a changed email address of a first client of a first system, wherein the update is managed by the first system. The method comprises providing an old email address and a new email address of the first client, and providing an email historical database associated with the first system in which information of the old and new email addresses are stored. The email historical database is in communication with the first system via a communication network. The method further comprises sensing a subsequent email address of a subsequent email message to be sent from a second client of the first system, and searching in the email historical database to determine whether the subsequent email address is the old email address of the first client. The method further includes redirecting the subsequent email message to the new email address of the first client, if the subsequent email address is determined to be the old email address of the first client.

It is another object of the present invention to provide an improved method of managing an update of an email address of a user, wherein the update is managed by the first system. The method comprises providing an old email address and a new email address of the user, providing an email historical database associated with the first system in which information of the old and new email addresses are stored. The email historical database is in communication with the first system via a communication network. The method further comprises providing a second system for a second client, wherein the second system is in communication with the first system via the communication network. The method further includes sending a subsequent email from the second client, wherein the subsequent email has a subsequent email address. The method further includes determining that the subsequent email is undeliverable, and searching in the email historical database to determine whether the address of the subsequent email is the old email address of the user. The method further comprises redirecting the subsequent email message to the new email address of the user, if the subsequent email address is determined to be the old email address of the user.

### BRIEF DESCRIPTION OF THE DRAWINGS

FIG. 1 is a schematic view of an embodiment of one system implemented in accordance with the present invention;

FIG. 2 is a flow chart depicting one embodiment of a method used with the system of FIG. 1 in accordance with the present invention;

FIG. 3 is a flow chart depicting another embodiment of a method used in accordance with the present invention;

FIG. 4 is a schematic view of another embodiment of a system implemented in accordance with the present invention;

FIG. 5 is a flow chart depicting one embodiment of a method used with the system of FIG. 4 in accordance with the present invention; and

FIG. 6 is a flow chart depicting another embodiment of a method used with the system of FIG. 4 in accordance with the present invention.

### DETAILED DESCRIPTION OF THE PREFERRED EMBODIMENT

The present invention allows an e-mail sender to correctly send email to a recipient even when the recipient fails to inform the sender of the recipient's changed e-mail address. The present invention allows the email sender to avoid inconveniences of manually searching for the recipient's updated or “new” email address in order to communicate via email. Merely using an “old” email address of the recipient is sufficient in sending the email to the recipient.

The present invention provides a simple, time efficient way for a system to update and/or manage a portfolio of email addresses within a database of the system, wherein the email addresses are old and new email addresses of the email user.

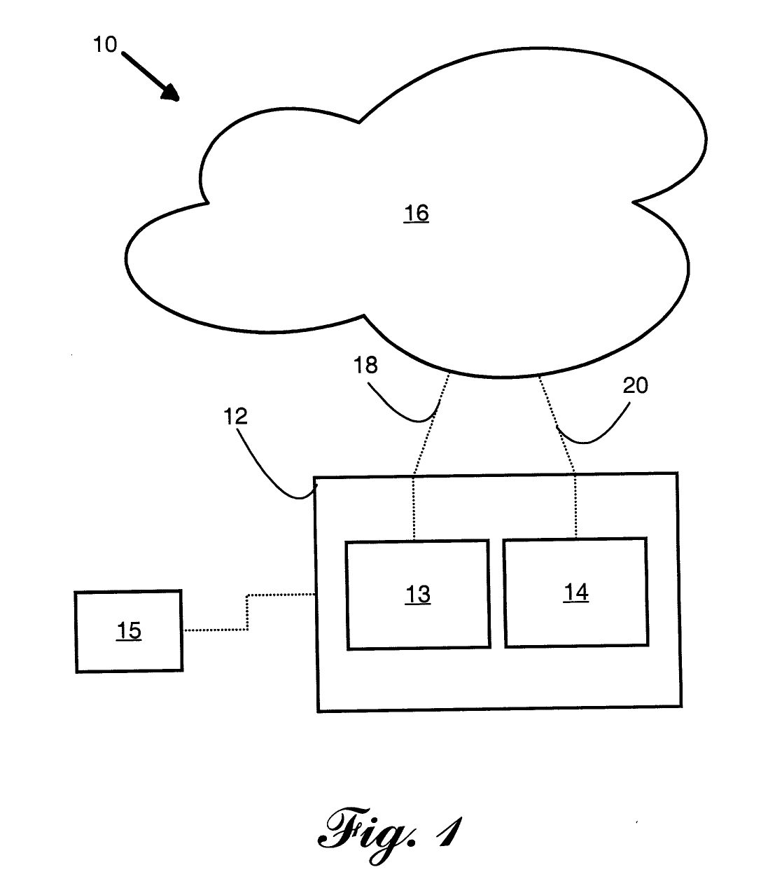

FIG. 1 schematically illustrates a computer-implemented email managing system 10 for managing an update of a changed email address of a first client of a first system, wherein the update is managed by the first system. As shown, email updating system 10 includes first client 13 and second client 14. First system 12 is associated with email historical database 15. First and second clients 13, 14 may be in communication with each other via communication network 16. First client 13 is in communication with communication network 16 by way of first communication means 18 and second client 14 is in communication with communication network 16 by way of second communication means 20. First and second communication means 18, 20 may be any suitable means of communicating first and second clients 13, 14 respectively to communication network 16. For example, as known in the art, communication means for communicating via the Internet may include a modem connected by a phone line to an operating regional server(s).

In this embodiment, first system 12 is associated with first and second clients 13, 14, wherein first system 12 provides Internet service to first client 13 and second client 14. Both the first and second clients are able to send and receive email messages via central processing units which communicate the clients via communication network 16. For example, first system 12 may be an Internet provider to first and second clients 13, 14 wherein first system 12 has Internet server(s), as known in the art, which allow communication between the clients via email. Of course, first and second clients, 13, 14 may be provided Internet service through different systems (described below). However, in this embodiment, it is to be noted that first and second clients 13, 14 have the same Internet provider by which the first and second clients, respectively, communicate.

It is to be noted that the preferred embodiment of the present invention is implemented by at least a central processing unit (CPU) and a monitor. The monitor displays selection windows of a graphical user interface with which the user interacts by using a conventional mouse, touch pad, and/or keyboard. The keyboard, mouse, or touch pad may, in turn, be in communication with a central processing unit which is in communication with the computer monitor. As known in the art, the CPU may include a modem connected to a phone line which allows the CPU to communicate to a remote server of a system for Internet connection.

In this embodiment, communication network 16 represents the Internet, as known, by which email messages may be sent and received between first and second clients 13, 14. Of course, communication network 16 may be a local area network (LAN), a metropolitan area network (MAN), a wide area network (WAN), or any other Intranet or area network available that provides an inter-connecting network which allows email to be received and sent between first and second clients 13, 14. In this embodiment, first system 12 represents a system of an Internet carrier/provider. Of course, system 12 may include systems of hard drives for central processing units, systems of local area networks, systems of metropolitan area networks, systems of wide area networks, and systems of any other Intranet. A client may be defined as a central processing unit of a user who is provided service by system 12. For example, first client 13 and second client 14 may be Internet subscribers/users of first system 12 which is an Internet provider/carrier. In this embodiment, email historical database 15 may be any suitable memory-storing means for storing information.

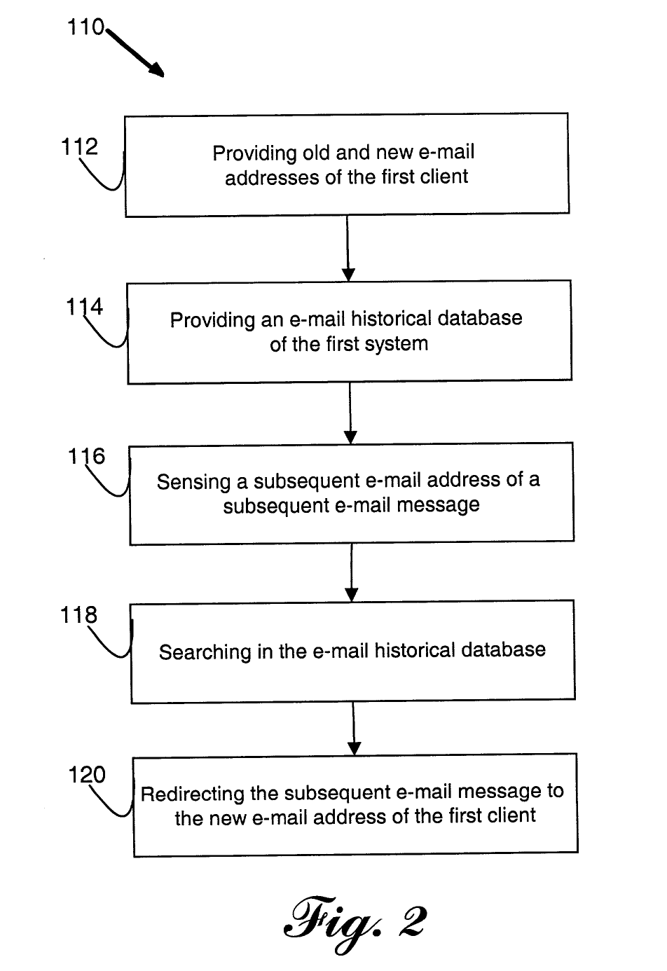

FIG. 2 illustrates a general method of the present invention in accordance with system 10 of FIG. 1 for managing an update of a changed email address of a first client of a first system, wherein the update is managed by the first system. In an event in which the first client 13 has an update from an “old” email address to a “new” email address, the first client may not choose to inform the second client of such change. In this embodiment, the present invention allows the first system to receive and manage the update such that the second client's subsequent email messages are not inadvertently sent to the first client's “old” email address. Rather, the present invention assures that the second client sends subsequent email messages correctly to the first client's new email address.

The method as generally shown in reference 110 of FIG. 2 preferably but not necessarily includes providing an old email address and a new email address of the first client 13 as shown in block 112. Method 110 further includes providing an email historical database 15 of the first system 12 in which information of the old and new email addresses are stored. The email historical database 15 is in communication with the first system 12 in block 114. In block 116, method 110 includes sensing a subsequent email address of a subsequent email message to be sent from second client 14 of first system 12, and in block 118, searching in the email historical database 15 to determine whether the subsequent email address is the old email address of the first client 13. Method 110 further includes redirecting the subsequent email message to the new email address of the first client 13, if the subsequent email address is determined to be the old email address of first client 13 in block 120.

It is to be noted that, in the preferred embodiment, a plurality of first clients may be involved in performing the method in accordance with the present invention. Thus, first system 12 manages a plurality of updates.

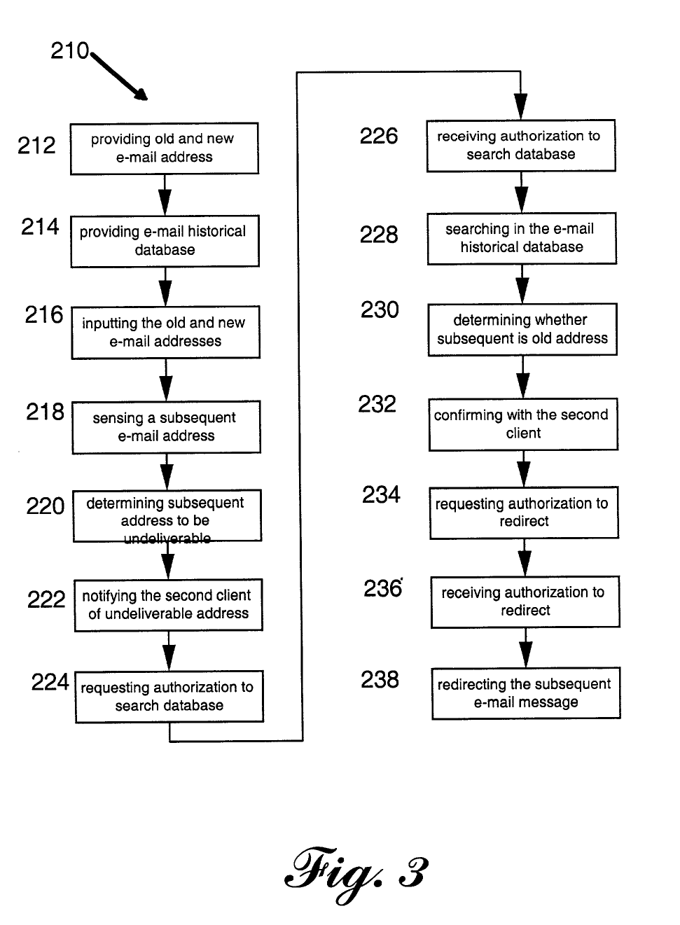

As shown, FIG. 3 illustrates an example of the general method of FIG. 2. In this embodiment, method 210 comprises a more specific methodology of steps of the present invention. Method 210 preferably but not necessarily comprises providing an old email address and a new email address of the first client 13. Method 210 further includes providing an email historical database 15 of first system 12 in which information of the old and new email addresses are stored, wherein the email historical database 15 is in communication with the first system 12 in block 214. Method 210 further includes inputting the old email address and the new email address into the email historical database 15 of first system 12 in block 216. Inputting the old and new email addresses into the email historical database may be performed by any known means of inputting data. Moreover, the addresses may be gathered by any suitable means.

Method 210 further includes sensing a subsequent email address of a subsequent email message to be sent from second client 14 of first system 12 in block 218, determining the subsequent email address to be undeliverable in block 220 and notifying the second client 14 that the subsequent email address is undeliverable in block 222. For example, after the step of inputting the old and new addresses into database 15, second client 14 may compare the subsequent email message intended to be sent via communication network 16 to first client 13. When the second client 14 sends the message (conventionally by “clicking” a “send” icon within a graphic window shown by a monitor), first system 12 senses that the subsequent email message has been sent, and determines whether the subsequent email message is undeliverable. This may be accomplished by configuring the first system 12 to be capable of identifying the address to which the subsequent email message is to be sent, and compare it with the old email addresses in database 15. If system 12 determines that the message is undeliverable, then system 12 may notify the second client 14 of this determination. This may be accomplished by sending a return email and informing the second client 14.

Method 210 further includes requesting authorization from second client 14 to search in the email historical database 15 to determine whether the subsequent email address is the old email address of first client 13 in block 224, and receiving authorization from second client 14 to search in the email historical database 15 in block 226. This may be accomplished by any suitable means. For example, attached to the return email may be an authorization icon wherein, when opened, the second client 14 is presented with a window which is configured to allow the second client to click “yes” or “no” for authorization or no authorization, respectively. Once clicked, the window may be sent back via email to first system 12 for handling in accordance thereto. In this embodiment, clicking “yes” confirms authorization to search database 15.

Method 210 further includes searching the email historical database 15 to determine whether the subsequent email address is the old email address of the first client 15 in block 228, determining whether the subsequent email address is the old email address of first client 13 in block 230, and confirming with the second client 14 that the subsequent email address is the old email address in block 232. For example, first system 12 may run a find search to attempt to match the subsequent email address with an email address stored in database 15 as an “old” email address. If a match is found, then system 12 may conclude that the subsequent email address is the “old” email address. In the event that database 15 includes additional information of the first client 13, system 12 may verify the identity of the first client and the recipient of the subsequent email message to be the same person or entity.

Method 210 further includes requesting authorization from second client 14 to redirect the subsequent email address to the new email address in block 234, receiving authorization from second client 14 to redirect the subsequent message to the new email address in block 236, and redirecting the subsequent email message to the new email address of the first client 13, if the subsequent email address is determined to be the old email address of the first client 13. The steps of requesting authorization and receiving authorization may be accomplished similarly as described above, i.e., with attachments having icons wherein windows allow the second client 14 to click “yes” for authorization or “no” for no authorization. Upon obtaining authorization from second client 14, system 12 may re-configure the address to which the subsequent email message is to be sent. The address will then include the new address of the first client.

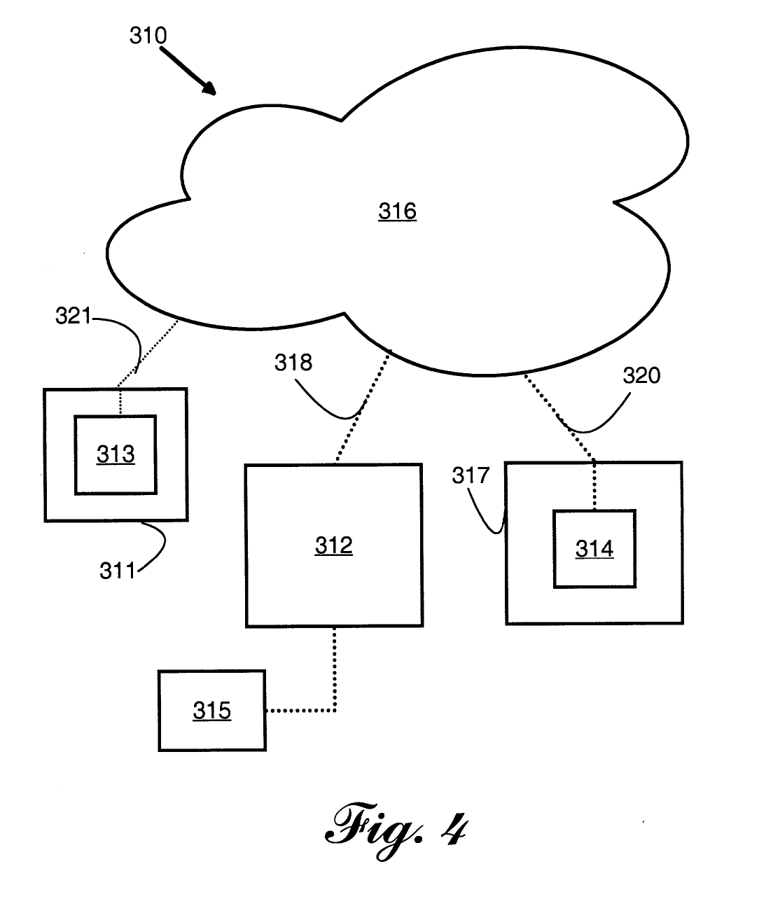

FIG. 4 schematically illustrates a computer-implemented method of managing an update of a changed email address of a user, wherein the update is managed by the first system. As shown, system 310 includes first system 312 associated with email historical database 315. Moreover, second system 317 is associated with second outside client 314, and third system 311 is associated with outside client or user 313. User 313 and second client 314 are in communication with each other via communication network 316. As shown, first system 313 is in communication with communication network 316 by way of first communication means 318. Second system 314 is in communication with communication network 316 by way of second communication means 320, and third system 311 is in communication with communication network 316 via third communication means 321. First, second, and third communication means 318, 320, 321 may by any suitable means for communicating first, second, and third systems 312, 317, 311 respectively to communication network 316. For example, as known in the art, communication means for communicating between systems via the Internet may include a modem connected by a phone line to operating regional servers. Communication network 316 may be the same network as communication network 16 described in the embodiment above.

In this embodiment, both the clients 313, 314 are able to send and receive e-mail messages with first and second systems 312, 317, respectively, via communication network 16. For example, first system 312 and second system 317 may be separate Internet providers having respective Internet servers, as known in the art, wherein communication network 16 represents the Internet.

It is to be noted that each user and client is implemented by at least a central processing unit (cpu) and a monitor. The monitor displays selection windows of a graphical user interface with which the user interacts by using a conventional mouse, touch pad, and/or keyboard. The keyboard, mouse, or touch pad may, in turn, is in communication with the central processing unit which is in communication with the computer monitor. As known in the art, the cpu may include a modem connected to a phone line which allows the cpu to communicate a remote server for Internet connection.

In this embodiment, communication network 316 represents the Internet, as known, by which e-mail messages may be sent and received between first and second systems 312, 314. Of course, communication network 316 may be a local area network (LAN), a metropolitan area network (MAN), a wide area network (WAN), or any other area network available that provides an interconnecting network which allows e-mail to be received and sent between first and second systems 312, 314. In this embodiment, first and second systems 312, 314 represents systems of Internet carriers/providers. Of course, systems 312, 314 may include systems of hard drives for central processing units, systems of local area networks, systems of metropolitan area networks, and systems of wide area networks. A client may be defined as a user of systems 311, 314 mentioned above. For example, the outside client may be an Internet subscriber/user of third system 311 which is an Internet provider/carrier. In this embodiment, database 315 may be any suitable memory-storing means for storing information.

In this embodiment, user 313 is associated with third system 311. However, it is to be noted that user 313 may be associated with any other system which does not fall beyond the scope or spirit of the present invention.

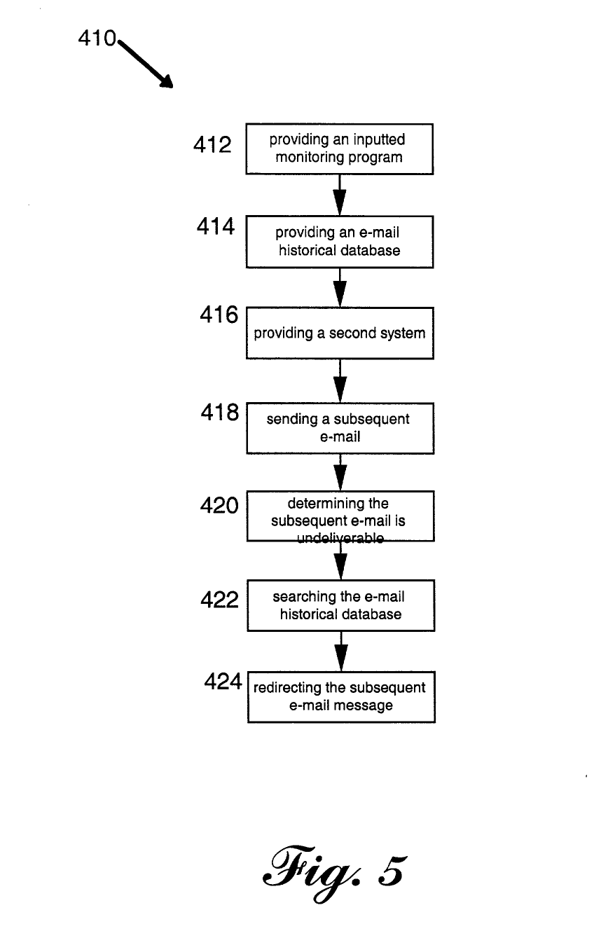

FIG. 5 illustrates method 410 of managing an update of a changed email address of a user, the update being managed by first system 312. Method 410 includes providing an old email address and a new email address of user 313 in block 412, and providing an email historical database 315 of first system 312 in which information of the old and new email addresses are stored in block 414. The email historical database 315 is in communication with first system 312 via communication network 316. Method 410 further includes providing a second system 317 for second client 314 in block 416, wherein second system 317 is in communication with first system 312 via communication network 316. Method 410 further includes sending a subsequent email from second client 314, wherein the subsequent email has a subsequent email address in block 418, determining the subsequent email is undeliverable in block 420, and searching in the email historical database 315 to determine whether the address of the subsequent email is the old email address of user 313 in block 422. Method 410 further includes redirecting the subsequent email message to the new email address of user 313, if the subsequent email address is determined to be the old email address of user 313 in block 424.

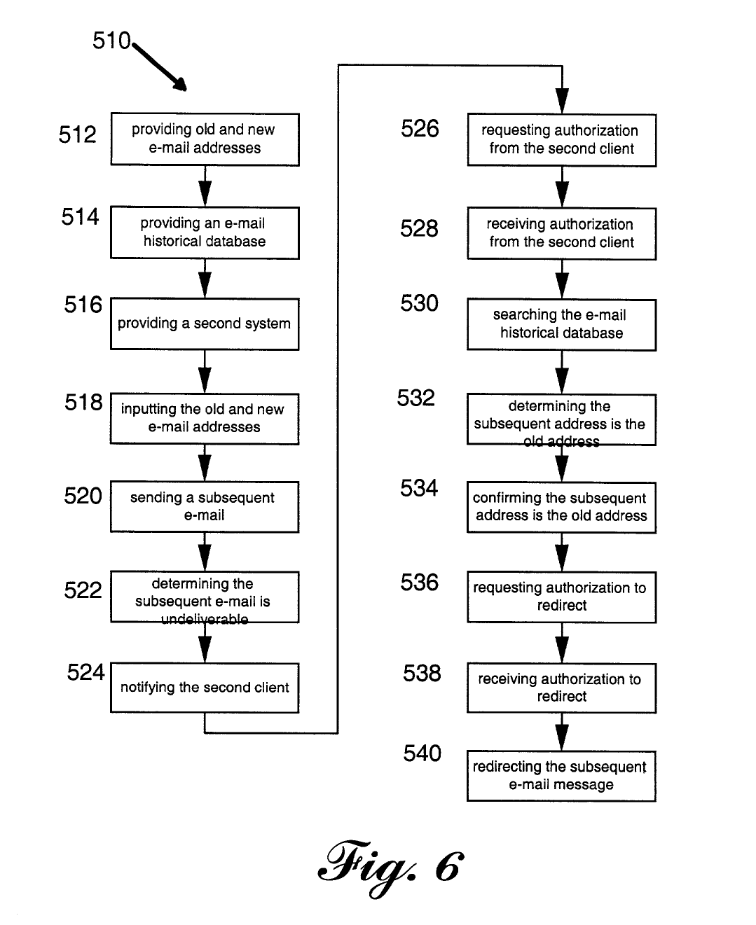

As shown, FIG. 6 illustrates an example of the general method of FIG. 5. In this embodiment, method 510 comprises a more specific methodology of steps of the present invention generally shown in method 410 in FIG. 5. Method 510 preferably but not necessarily comprises providing an old email address and a new email address of user 313 in block 512, and providing an email historical database 315 of first system 312 in which information of the old and new email addresses are stored in block 514. Email historical database 315 is in communication with first system 312 via communication network 316. Method 510 further includes providing second system 317 for second client 314 in block 516, wherein second system 317 is in communication with first system 312 via communication network 316 in block 516. Method 510 further includes inputting the old email address and the new email address into the email historical database 513 of the first system 312 in block 518.

Method 510 further includes sending a subsequent email from second client 314 in block 520, wherein the subsequent email has a subsequent email address in block 520. This may be accomplished by typing in an email window an address to which the email is to be delivered and clicking a “send” icon within the email window.

Method 510 further includes determining the subsequent email is undeliverable in block 522, notifying the second client 314 of second system 317 that the subsequent email address is undeliverable in block 524, and requesting authorization from second client 314 to search in the email historical database 315 to determine whether the subsequent email address is the old email address of user 313 in block 526. The step of determining in block 522 may be accomplished by any suitable means. For example, second system 317 may offer to its subscribers or clients such as second client 314 an undeliverable notification feature as typically provided. If so, then second system 317 may be configured to sense and automatically respond to such situations wherein notification has been provided to a subscriber/client of second system 317. Thus, second system 317 may be configured to request authorization from the second client 314 to search database 315 in the same manner as in the embodiment described above, i.e., with an attached authorization icon and window.

Method 510 further includes receiving authorization from second client 314 to search in the email historical database 315 in block 528, searching in the email historical database 315 to determine whether the address of the subsequent email address is the old email address of the user in block 530, and determining whether the subsequent email address is the old email address of the user 313 in block 532. After authorization is received, database 315 may be searched by second system 314 or by first system 312, allowing the determination of whether to subsequent email address is the old email address of user 313. This may be accomplished in the same manner as in the embodiment described above.

Method 510 further includes confirming with second client 314 that the subsequent email address is the old email address in block 534, requesting authorization from the second client 314 to redirect the subsequent email message to the new email address in block 536, and receiving authorization from the second client 314 to redirect the subsequent message to the new email address in block 538. Furthermore, method 510 includes redirecting the subsequent email message to the new email address of the user 313 in block 540, if the subsequent email address is determined to be the old email address of the user 313. These steps may be accompllished in the manner as described in the embodiment above.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of managing an update of a changed email address of a first client of a first system, the update being managed by the first system, the method comprising:
providing an old email address and a new email address of the first client;
providing an email historical database associated with the first system in which information of the old and new email addresses are stored, the email historical database being in communication with the first system via a communication network;
sensing a subsequent email address of a subsequent email message to be sent from a second client of the first system;
searching in the email historical database to determine whether the subsequent email address is the old email address of the first client; and
redirecting the subsequent email message to the new email address of the first client, if the subsequent email address is determined to be the old email address of the first client.

2. The method of claim 1 further comprising inputting the old email address and the new email address into the email historical database associated with the first system.

3. The method of claim 2 wherein inputting the old and new email addresses is performed during a period of the first client's subscription with the first system.

4. The method of claim 1 further comprising:
determining the subsequent email address to be undeliverable;
notifying the second client that the subsequent email address is undeliverable;
requesting authorization from the second client to search in the email historical database to determine whether the subsequent email address is the old email address of the first client; and
receiving authorization from the second client to search in the email historical database.

5. The method of claim 1 further comprising determining whether the subsequent email address is the old email address of the first client.

6. The method of claim 5 further comprising confirming with the second client that the subsequent email address is the old email address.

7. The method of claim 1 wherein the information includes data indicative of the first client.

8. The method of claim 7 wherein the information includes the old email address of the first client, the new email address of the first client, identification of the first client, effective date of the update, and time period of the update.

9. The method of claim 1 further comprising:
requesting authorization from the second client to redirect the subsequent email message to the new email address; and
receiving authorization from the second client to redirect the subsequent message to the new email address.

10. The method of claim 1 wherein the first system includes a system of an Internet carrier, a system of a hard-drive for a central processing unit, a system of a local area network, a system of a metropolitan area network, and system of a wide area network.

11. The method of claim 1 wherein the communication network includes a local area network, a metropolitan area network, a wide area network, the Internet, and an Intranet.

12. A method of managing an update of a changed email address of a user, the update being managed by a first system, the method comprising:
providing an old email address and a new email address of the user;
providing an email historical database associated with the first system in which information of the old and new email addresses are stored, the email historical database being in communication with the first system via a communication network;
providing a second system for a second client, the second system being in communication with the first system via the communication network;
sending a subsequent email from the second client, the subsequent email having a subsequent email address;
determining the subsequent email is undeliverable;
searching in the email historical database to determine whether the address of the subsequent email is the old email address of the user; and
redirecting the subsequent email message to the new email address of the user, if the subsequent email address is determined to be the old email address of the user.

13. The method of claim 12 further comprising inputting the old email address and the new email address into the email historical database associated with the first system.

14. The method of claim 12 further comprising:
notifying the second client of the second system that the subsequent email address is undeliverable;
requesting authorization from the second client to search in the email historical database to determine whether the subsequent email address is the old email address of the user; and
receiving authorization from the second client to search in the email historical database.

15. The method of claim 12 further comprising determining whether the subsequent email address is the old email address of the user.

16. The method of claim 15 further comprising confirming with the second client that the subsequent email address is the old email address.

17. The method of claim 12 wherein the information includes data indicative of the user.

18. The method of claim 17 wherein the information includes the old email address of the user, the new email address of the user, identification of the user, effective date of the update, and time period of the update.

19. The method of claim 12 further comprising:
requesting authorization from the second client to redirect the subsequent email message to the new email address; and
receiving authorization from the second client to redirect the subsequent message to the new email address.

20. The method of claim 12 wherein the first system includes a system of an Internet carrier, a system of a hard-drive for a central processing unit, a system of a local area network, a system of a metropolitan area network, and system of a wide area network.

21. The method of claim 12 wherein the second system includes a system of an Internet carrier, a system of a hard-drive for a central processing unit, a system of a local area network, a system of a metropolitan area network, and system of a wide area network.

22. The method of claim 12 wherein the communication network includes a local area network, a metropolitan area network, a wide area network, the Internet, and an Intranet.
